(19) United States
(12) Patent Application Publication
(10) Pub. No.: US 2002/0087842 A1
(43) Pub. Date: Jul. 4, 2002

(54) Method and apparatus for performing architectural comparisons

(76) Inventor: Ronald D. Smith, Phoenix, AZ (US)

Correspondence Address: Kenyon & Kenyon, Suite 600, 333 W. San Carlos Street, San Jose, CA, 95110-2711, US

(21) Appl. No.: 09/751,761

(22) Filed: Dec. 29, 2000

(51) Int. Cl. G06F 9/00

(52) U.S. Cl. 712/227

(57) ABSTRACT

A method and apparatus for testing a processor is described. In one embodiment, a NOP PSR generates error checking NOP instructions during a pipeline stall. The insertion of these numerous NOP instructions ensure the fact that the checking hardware checks more frequently and has more locations to check. Also, taking advantage of modem processor optimizations for handling NOPs minimizes any impact on processor performance.

### BACKGROUND OF THE INVENTION

The present invention pertains to a method and apparatus for performing architectural comparisons. More particularly, the present invention pertains to neutral instruction generation that can perform error checking without changing the processor system's architectural state.

As is known in the art, redundant processors are used to provide results with an extremely high level of reliability. Historically, extremely high reliability computers have opted for triple or quadruple voting redundancy. This design was most often used in spacecraft, which were either exposed to high radiation environments (like interplanetary exploration robotic craft) or where there was an absolute intolerance to mission failure (like manned missions including the Space Shuttle). For example, with three processors, each processor simultaneously executes the identical program on identical data, and theoretically should compute and output the same results. Voting circuits ensure that all results are identical, and in the presence of discrepancies, if at least two of the results agree, the third is discarded. In the event of failures, either a reset sequence is initiated or, in the worst case scenario, the offending computer is disabled.

Modern process technologies are driving microprocessor dimensions smaller and smaller, allowing the circuits to become increasingly sensitive to single event upsets, such as from cosmic rays, alpha particles, or other transient and non-damaging errors. Even transient errors may not be acceptable within certain industry applications, such as transaction processing systems within the banking industry. This invention seeks to minimize these silent data corruption events.

The largest components of modem microprocessors (by area) are large arrays of memory. As is known in the art, memory arrays have a well understood error detection and correction mechanism whereby syndrome bits are generated alongside data such that single bit errors can be corrected and multiple bit errors can be detected. However, the core logic, logic that implements the computation and executes the program instructions, lacks the ability to check for errors.

One solution has been to connect logic cores together in parallel with comparison circuits between them. A limitation to the comparison circuits is that it does not yield true-nonstop computing. In the event of a discrepancy, the correct answer is unknown. Another limitation of the comparison circuits is that the only opportunity to check the architectural equivalency is through the execution of instructions. Thus, the ability to detect errors is limited to what the instructions actually do. An example is an application that is expected to run for an extended period of time (e.g., hours or days). As the application starts, it initializes a given architectural register to a value. As the application execution proceeds, it does not make reference to this register again for the extended period. Thus, if the value in the register has been corrupted during this extended period of time, there is currently no method by which to catch the error earlier in between the two references to the register.

In view of the above, there is a need for an improved method and apparatus for performing architectural comparisons.

### BRIEF DESCRIPTION OF THE DRAWINGS

FIG. 1 is a block diagram of a portion of a processor employing an embodiment of the present invention.

FIG. 2 is a flow diagram showing an embodiment of a method according to an embodiment of the present invention.

FIG. 3 is a block diagram of a computer system operated according to an embodiment of the present invention

### DETAILED DESCRIPTION OF THE DRAWINGS

In various known architectures such as RISC (Reduced Instruction Set Computing), CISC (Complex Instruction Set Computing), VLIW (Very Long Instruction Word), and EPIC (Explicitly Parallel Instruction Computing), an instruction may be provided to the execution unit that results in no significant task performance for the processor system. In the Intel®×86 processor systems, an example of such an architecturally neutral instruction is the NOP (No operation) instruction. NOP instructions can make up a significant percentage of programming code. In a typical VLIW application using current compilers, they can account for up to 30% of code density.

In general, neutral instructions are rarely unique in their data pattern, but instead, can be specified in many ways. For example, an instruction which logically ORs a zero to a specified register could be a neutral instruction because nothing changes in the architectural state of the processor. However, since there are many possible specifications for the register, there are in fact many neutral instructions. Thus, the present invention serves to define a class of neutral check instructions. One purpose of these neutral check instructions may be to notify the hardware to perform a comparison operation among the redundant processors.

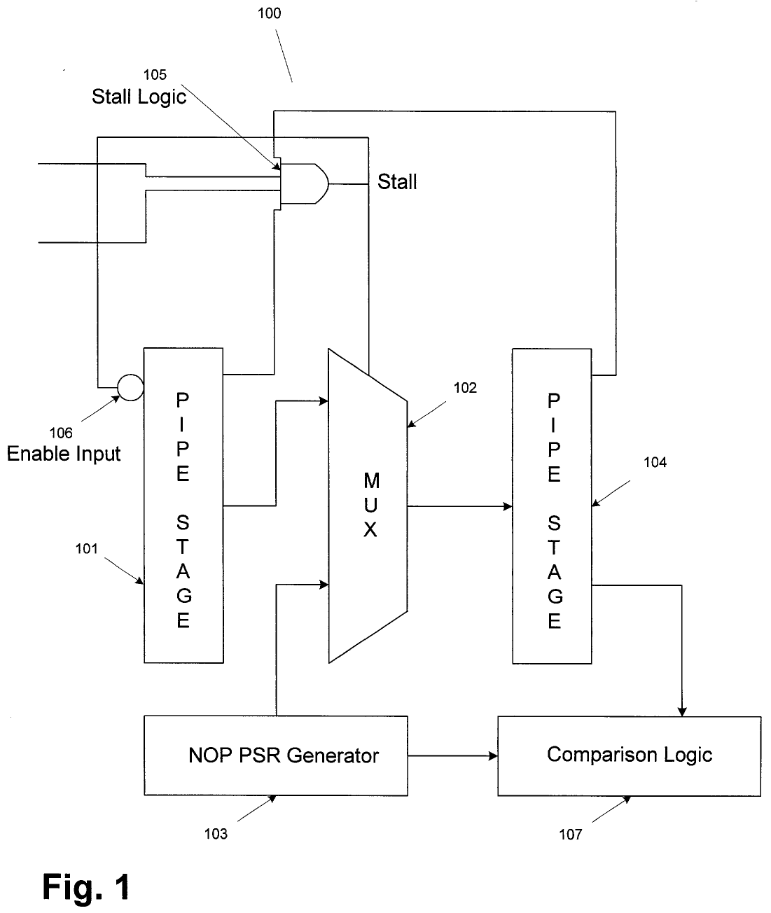

Referring to FIG. 1, a block diagram of an execution pipeline operated according to an embodiment of the present invention is shown. In this example, execution pipeline 100 includes separate pipe stages 101 and 104 (i.e., these pipe stages include fetch units, decode units, execution units, and/or retire units). In this example, the instructions from the pipe stage 101 are supplied to a multiplexer (MUX) 102. In the event of fundamental resource conflicts (e.g., read after read may not be able to be done in one cycle) or resource dependencies (e.g., operations which tie up execution units for a time such as system memory accesses), generalized stall logic 105 asserts stall signals to enable input 106. Enable input 106 stops each active pipeline stage so that the information in that pipeline stage does not advance to the next pipeline stage. During the stall, a neutral instruction generator (e.g., NOP pseudo random (PSR) instruction generator 103) is coupled to MUX 102 and supplies NOP instructions with a pseudo random value in order to detect errors. The neutral instruction, when executed, ascertains an architectural state value for the processor system (e.g., by performing a neutral operation on a register specified by the pseudo random value). These error checking NOP instructions continue down the execution pipeline in a normal fashion to pipe stage 104. Comparison logic 107, coupled to both neutral instruction generator (NOP PSR generator 103) and pipe stage 104, receives inputs from each unit. NOP PSR generator 103 supplies the register to be checked and pipe stage 104, which executes the check instruction, provides a value from each location. After the conflicts or dependencies of the stall have been resolved, enable input 106 re-activates the advancement of instructions into MUX 102 for normal execution down the pipeline, thus temporarily halting the insertion of instructions by the neutral instruction generator.

According to this embodiment of the present invention, the insertion of the error checking NOP instructions into the execution pipeline is directed by NOP PSR generator 103 during pipeline stalls. The PSR value randomly points to various architectural state values based upon the instruction. These values extend to, but are not limited to, the processor registers (e.g., floating point registers and application registers), the memory cache contents, and hidden architectural states (e.g., the hidden information in other components known in the art such as translation look-aside buffers or a branch prediction buffer). In this embodiment, the NOP PSR generator 103 provides the random alternate values, not the actual random instruction itself. For example, an error checking NOP instruction may specify ORing a zero to a specified register, and as such, the PSR generator would supply the identification of the specific register. An advantage of this insertion between instructions provided by the actual application is that these NOP instructions would not have any architectural side effects.

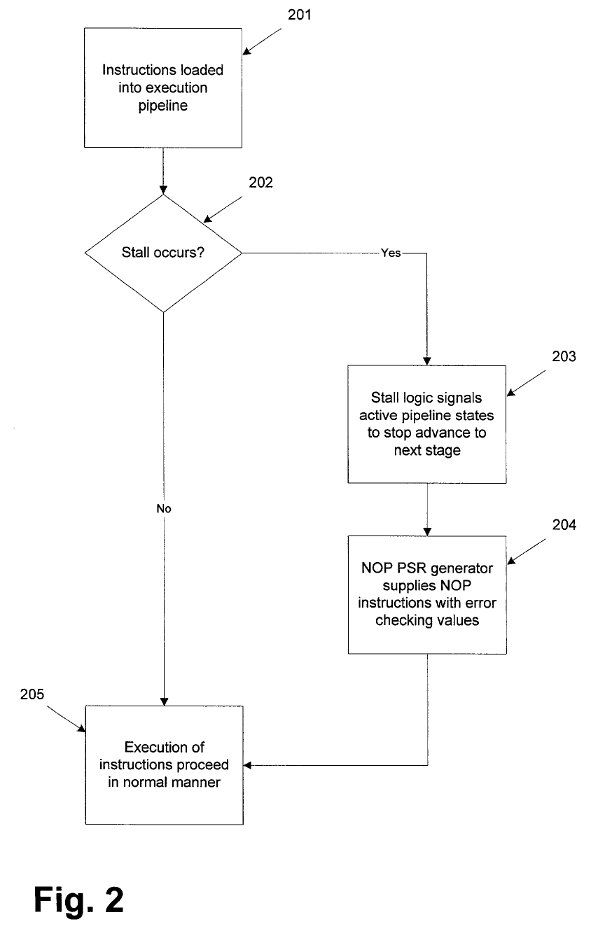

An example of the operation of the NOP PSR generator 103 in this embodiment is shown in FIG. 2. In block 201, the instructions are loaded into the execution pipeline 100. In decision block 202, it is determined whether any stalls have occurred. If there are, then control passes to block 203 where the stall logic signals to each of the active pipeline stages to stop its advance of information to the next pipeline stage. Control then passes to block 204, where the NOP PSR generator supplies NOP instructions with pseudo random values to detect errors in various locations. The execution of these error checking NOP instructions proceed in a normal manner, in block 205. If there are no stalled instructions within the pipeline (decision block 202), control proceeds to block 205 where instructions are executed in a normal manner.

Modern processors are optimized to process the volume of NOP instructions. Both the large number of NOPs and methods to optimize NOPs serve to favor the error checking method of the present invention. While the large number of NOP instructions guarantee an equally large number of error checks, the current optimization of NOPs ensure that these numerous checks will not decrease processor performance. Thus, by taking advantage of how standard NOPs are handled by processors, a significant increase in processor testing and architectural equivalency can be achieved.

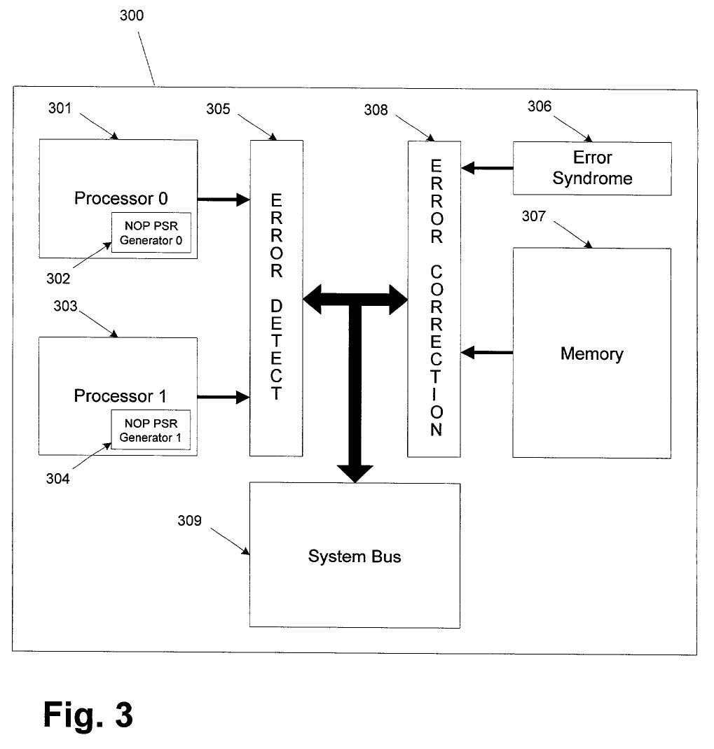

Referring to FIG. 3, a block diagram of a computer system operated according to an embodiment of the present invention is shown. In this example, the computer system 300 includes a processor 0, 301, with NOP PSR generator 0, 302, and a processor 1, 303, with NOP PSR generator 1, 304. The two processors are coupled to error detection unit 305. In this example, error detection unit 305 utilizes the results of all instructions, including the NOP check instructions for error checking. The computer system 300 also includes off-chip memory 307 and error syndrome unit 306, both coupled to error correction code unit 308. As is known in the art, error correction code unit 308 can detect single bit errors in memory and correct them. Multiple bit errors in memory can be detected by error correction unit 308, but cannot correct them. Both error units, error detect unit 305 and error correction code unit 308 are coupled to the system bus 309.

For functionally redundant designs, the implementation of a NOP instruction could be altered to provide additional security by using the NOP instruction to provide architectural visibility of the specified result to the comparison logic. When the NOP instruction is decoded, it would not be discarded, but in fact would fetch its appropriate operands, do nothing, and provide the architectural result to the comparison logic. Even though nothing changes, the act of checking the operands periodically guarantees that there is a maximum error lifetime between checks. By inserting a controlled variety of NOP instructions, all architectural features of the machine can be periodically made available to the error check and since there are a fairly large number of NOP opportunities, this comes for free without any extra demand placed on processor resources. An advantage to this implementation of NOP instructions is that should there be scheduling conflicts or other operand access conflicts, these NOPs do not appear in the instruction stream and can be discarded at will without damage.

According to an embodiment of the present invention, these error checking NOP instructions can be utilized without the implementation of hardware (i.e., the NOP PSR generator). There are several ways this could be implemented: 1) A compiler could maintain heuristics as to the lifetime of various pieces of state information, and could insert specific NOPs into the program instructions to test those pieces of state. In this way, there would be enhanced error protection incorporated seamlessly and transparently in the program. 2) A post processor could scan the resulting code stream, altering the standard NOPs that were inserted by the compiler, creating a new code stream in a separate operation. Since this post-processing program would not necessarily have the same visibility into the actual execution of the program that the compiler could, it would choose NOPs that appear more random in their testing impact. 3) The operating system program loader could implement the post processing system as each program is loaded into memory. In this case, the modified NOPs could be the same from program start to program start or could vary between loads.

According to this embodiment of the present invention, these implementations complement the VLIW type of architectures because of the opportunities present in the architecture. For example, in VLIW architectures, there is a natural background of NOPs to take advantage of because of the difficulty of filling all computational slots. For other architectures, such as RISC or CISC, NOPs are generally undesirable because they waste computational resources. However, the same principals may be applied to these architectures as is described above. In these cases, there is a trade-off between the performance lost to the inserted NOPs and the additional security the error checking NOPs provide.

As seen from above, the use of error checking NOP instructions works to ensure a maximum error lifetime without inhibiting overall system performance within redundant processors. This is because the insertion of these numerous NOP instructions ensure the fact that the checking hardware checks more frequently and has more locations to check. Also, taking advantage of modern processor optimizations for handling NOPs minimizes any impact on processor performance.

Although several embodiments are specifically illustrated and described herein, it will be appreciated that modifications and variations of the present invention are covered by the above teachings and within the purview of the appended claims without departing from the spirit and intended scope of the invention. For example, there are many examples of neutral instructions that do not affect the architectural state of the processor. These include the following: XORing the contents of a memory location with itself, adding 0 to such a value, ANDing the value with 1, ORing the value with 0, etc. Whether an instruction is neutral will depend on the definition of the instruction, its operands, and how it affects memory contents including flags.

What is claimed is:

1. A method for testing a processor including an execution stage comprising:
generating a neutral instruction;
providing said neutral instruction to execution stage of said processor; and
executing said neutral instruction to ascertain an architectural state value for said processor.

2. The method of claim 1 wherein said neutral instruction is generated when a plurality of instructions are generated by a compiler.

3. The method of claim 1 wherein said neutral instruction is generated by a No-operation (NOP) pseudo-random generator.

4. The method of claim 3 wherein the execution of said neutral instruction causes said processor to access a value stored in a register in said processor.

5. The method of claim 1 wherein the execution of said neutral instruction causes said processor to access a value stored in a register in said processor.

6. The method of claim 1 wherein said neutral instruction is generated by a post-processor device.

7. A system for testing a processor including an execution stage comprising:
comparison logic coupled to the execution stage of said processor, wherein said execution unit is execute a neutral instruction to ascertain an architectural state value for said processor.

8. The system of claim 7 wherein said neutral instruction is generated by a compiler.

9. The system of claim 7 further comprising:
a No-operation (NOP) pseudo-random generator coupled to the execution unit of said processor to generate said neutral instruction.

10. The system of claim 9 wherein the processor includes a register and the execution of said neutral instruction causes said processor to access a value stored in the register in said processor.

11. The system of claim 10 wherein said neutral instruction includes XORing the contents of said register with itself.

12. The system of claim 10 wherein said neutral instruction includes ANDing the contents of said register with all binary 1 values.

13. The system of claim 10 wherein said neutral instruction includes ORing the contents of said register with all binary 0 values.

14. A set of instructions residing in a storage medium, said set of instructions capable of being executed in an execution stage by a processor for implementing a method to test the processor, the method comprising:
generating a neutral instruction;
providing said neutral instruction to the execution stage of said processor; and
executing said neutral instruction to ascertain an architectural state value for said processor.

15. The set of instructions of claim 14 wherein in said method said neutral instruction is generated when a plurality of instructions are generated by a compiler.

16. The set of instructions of claim 14 wherein in said method said neutral instruction is generated by a No-operation (NOP) pseudo-random generator.

17. The set of instructions of claim 16 wherein in said method the execution of said neutral instruction causes said processor to access a value stored in a register in said processor.

18. The set of instructions of claim 14 wherein in said method the execution of said neutral instruction causes said processor to access a value stored in a register in said processor.

19. The set of instructions of claim 14 wherein in said method said neutral instruction is generated by a post-processor device.
